(19) United States
(12) Patent Application Publication
(10) Pub. No.: US 2002/0058165 A1
(43) Pub. Date: May 16, 2002

(54) Mehtod for cold-starting a fuel cell battery and fuel cell battery suitable therefor

(76) Inventors: Ulrich Gebhardt, Langensendelbach (DE); Gunter Luft, Lauf (DE); Konrad Mund, Uttenreuth (DE); Manfred Waidhas, Nurnberg (DE); Rittmar Von Helmolt, Mainz (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/950,426

(22) Filed: Sep. 10, 2001

Related U.S. Application Data
(63) Continuation of application No. PCT/DE00/00742, filed on Mar. 9, 2000.

(30) Foreign Application Priority Data
Mar. 9, 1999 (DE) 199 10 386.0

(51) Int. Cl. H01M 8/04; H01M 8/06

(52) U.S. Cl. 429/13; 429/21; 429/26; 429/20

(57) ABSTRACT

A fuel cell battery having an improved cold-starting performance and a method for cold-starting a fuel cell battery, use reaction heat of an oxyhydrogen gas reaction in the fuel cell for heating. Reaction gas is simply supplied as required into the reaction chamber during starting, so that an electrode of the fuel cell unit acts as a catalytic burner.

### CROSS-REFERENCE TO RELATED APPLICATION

This application is a continuation of copending International Application No. PCT/DE00/00742, filed Mar. 9, 2000, which designated the United States.

### BACKGROUND OF THE INVENTION

1. Field of the Invention

The invention relates to a method for cold-starting a fuel cell battery, in which a fuel cell stack is formed by stacking individual fuel cells and in which waste heat from combustion of a primary and/or a secondary fuel is used for heating the fuel cell stack. The invention also relates to a fuel cell battery having such characteristics and being suitable for carrying out the method. The behavior during cold starting of a fuel cell battery is referred to as cold-starting performance.

European Patent Application EP 0 924 163 A2 discloses a method for water-vapor reformation of a hydrocarbon or hydrocarbon derivative, as well as a reformation system which can be operated in that way and a fuel cell operating method. In that method and system, heat from an external catalytic burner device is used for heating the system during cold starting.

A fuel cell battery has an electrolyte for each fuel cell unit, for example an ion exchanger membrane, having a main component which is a sulfonized chemical compound, in a PEM fuel cell. That group of chemical compounds binds water in the membrane, in order to ensure adequate proton conductivity. At a temperature below 0° C., the membrane resistance suddenly rises by 2-3 powers of ten as a result of the freezing of water that is stored there. In the case of other low-temperature and medium-temperature fuel cells, for example a PAFC (Phosphoric Acid Fuel Cell), there is also an electrolyte in which the resistance rises many times at low temperatures. That makes it very much harder to cold-start fuel cell batteries.

In order to solve that problem, either the battery, without being used, can be operated with a minimal load when the environmental temperature is low, in order to ensure that the temperature does not fall below the freezing point, or a thermal sensor can be installed so that the battery starts, and is heated up by operation, at the moment when the temperature falls sufficiently far that the electrolyte resistance threatens to rise suddenly. What is referred to as short-circuit operation is also possible, in which the battery is continuously short-circuited in the heating-up phase, so that all of the fuel cell power is used as short-circuit heat for heating up the electrolyte when operation starts.

However, short-circuit operation has the disadvantage of requiring that an extremely high electrolyte internal resistance be overcome at temperatures below the freezing point, before the cell starts to run and can therefore be heated up.

Furthermore, German Published, Non-Prosecuted Patent Application DE 40 33 286 A1 discloses a method for conversion of energy, which is in the form of chemical potential energy in a material, into electrical energy through the use of a fuel cell. In that method, at least one portion of the reaction product water vapor and carbon dioxide is caused to react endothermically and chemically in the gas mixture with at least one portion of the primary energy carrier. That heat which is produced is intended to be used for regulating the temperature of the fuel cell. The further prior art, for example Patent Abstracts of Japan Publication Nos. 63-225477 and JP 58-119168 A, in principle discloses how, by supplying combustion gas in conjunction with the catalyst, the latter can be used as a catalytic burner and the energy can be used for heating the fuel cell during cold starting, with process gas always being consumed. In that context, Patent Abstracts of Japan Publication Nos. 61-158672, 63-205058, 61-118972, 63-236262, 01-134870, 01-132062 and 08-148175 disclose different versions of specific fuel cell types.

Therefore, the only methods which are known for cold starting a fuel cell battery are those in which the consumption of reaction gas is drastically increased during starting, or which require very long starting times.

### SUMMARY OF THE INVENTION

It is accordingly an object of the invention to provide a method for cold-starting a fuel cell battery using as little energy as possible and an improved fuel cell battery which is suitable therefor and which can be started even at low temperatures without an increased consumption of process gas, that overcome the hereinafore-mentioned disadvantages of the heretofore-known methods and devices of this general type.

With the foregoing and other objects in view there is provided, in accordance with the invention, a method for cold-starting a fuel cell battery, which comprises providing a fuel cell stack having stacked individual fuel cells with reaction chambers. Dosed reaction gas is produced as required in situ by electrolysis in at least one of the reaction chambers of one of the fuel cells. The fuel cell stack is heated with waste heat from combustion of a primary and/or a secondary fuel by using all surfaces covered with a catalyst subjected to both reaction gases as catalytic burners for the reaction gas during cold starting.

With the objects of the invention in view, there is also provided a fuel cell battery for cold-starting, comprising at least one fuel cell unit including a centrally disposed electrolyte/electrode unit, reaction chambers each disposed on a respective side of the electrolyte/electrode unit, and axial process gas channels. At least one additional line leads into at least one of the reaction chambers and/or bipolar plates, to produce reaction gas there in situ by electrolysis during starting, for using surfaces covered with a catalyst as a catalytic burner.

In accordance with another feature of the invention, the additional line produces a connection between the process gas channel for the oxidant and the anode, and/or the process gas channel for the fuel and the cathode. This connection can be equipped with a metering valve. The metering valve is advantageously controlled automatically through a controller to which, for example, the temperature in the anode and/or cathode chamber is supplied as a controlled variable.

In accordance with a further feature of the invention, the additional line produces an electrical contact between the two electrodes and/or the adjacent bipolar plates and an external voltage source. Therefore, oxygen can be deliberately produced in situ in the anode chamber, and/or hydrogen can be deliberately produced in situ in the cathode chamber, by electrolysis and possibly by periodic polarity reversal of the cell. In this case, the amount of reaction gas that is produced can be controlled directly through the amount of current being supplied.

In accordance with an added feature of the invention, the fuel cell battery is formed of PEM fuel cells with a sulfonized membrane, and the reaction gas is to be supplied as required in an amount which ensures that the temperature at the catalyst does not exceed 100° C.

In accordance with an additional feature of the invention, apart from the electrodes inside and/or outside the reaction chamber, additional parts such as gas inlets and outlets, a bipolar plate and/or gas distribution and/or collecting channels are covered with the catalyst. Therefore, oxidation and/or reduction takes place at these points as soon as reaction gas is supplied as required with heat being produced.

In accordance with yet another feature of the invention, the fuel cell battery includes at least one stack with a fuel cell unit, which is referred to as a stack, the corresponding process gas inlet and outlet channels (axial process gas channel), a cooling system and associated endplates. A reformer can be integrated in the fuel cell system, or can be operated externally.

In accordance with yet a further feature of the invention, the process gas channel is, for example, connected directly to an oxygen or fuel tank, to a compressor and/or to a hydrogen and/or reformer gas (temporary) storage device, or else preferably through a reformer, to a primary fuel line (natural gas line).

In accordance with yet an added feature of the invention, the reformer gas or hydrogen gas can be temporarily stored for cold starting and is introduced as required into the cathode area during cold starting.

In accordance with yet an additional feature of the invention, the at least one additional line into a reaction chamber is preferably connected directly to a process gas channel.

A PEM fuel cell battery is preferably used, but the use of the invention with other fuel cells, in particular PAFCs is, of course, possible.

A fuel cell unit includes a centrally disposed electrolyte, that is to say disposed in the center, which has an electrode on both sides and, in the case of PEMs, is covered with an electrical catalyst, like a sandwich. As soon as both reaction gases are present, that is to say as soon as fuel is supplied as required into the reaction area, which is normally filled with oxidant, for example, the electrode acts like a catalytic burner, that allows controlled combustion of the reaction gas mixture and heats itself and its environment in the process.

A catalytic burner is distinguished by the fact that a highly exothermic reaction takes place there in a controlled manner with the aid of a catalyst, so that the exothermic energy which is released can be used as heat. In this case, there is also no open flame during combustion, with the catalytic burner producing only heat.

The gas of the pure reactant is referred to as reaction gas, while the gas/liquid mixture which is introduced into the reaction chamber is referred to as process gas. The process gas has a number of components, such as water vapor, inert gas, etc. in addition to the reaction gas, and may also include primary fuel (before or after reformation).

Gasoline, methanol, methane, etc. can be used as the primary fuel, that is to say fuels from which a secondary fuel, such as hydrogen or a gas mixture containing hydrogen, is produced in a reformer. Hydrogen may also be the primary gas, for example if hydrogen is stored.

The reaction chamber is either the cathode chamber or the anode chamber. In principle, the reaction chamber is formed by an area between the electrode and the bipolar plates. At least one process gas inlet channel and one process gas outlet channel lead into this chamber. Both of the channels are generally installed axially in the fuel cell stack, and are therefore also referred to as axial process gas channels. Gas distribution and collecting channels, which are often integrated in the bipolar plates, lead from the gas inlet to the gas outlet. All of the surfaces of the reaction chamber may be covered with catalyst, so that the surfaces which are covered with the catalyst may be used as catalytic burners not only in the immediate vicinity of the electrolyte on the electrode, but everywhere in the reaction chamber.

It is also possible for the stack to be additionally heated by heated gases flowing through it, for example from the reformer, or simply by outputting the reformer heat through a heating circuit, so that the stack is heated not just by the combustion and/or oxidation in the reaction chamber itself, but is also supplied with heat from the exterior.

The primary application of the invention is in the mobile and decentralized area, but its use in the stationary area is also clear.

The invention for the first time discloses a method for cold-starting of a fuel cell battery, which operates simply, economically and effectively.

We claim:

1. A method for cold-starting a fuel cell battery, which comprises:
providing a fuel cell stack having stacked individual fuel cells with reaction chambers;
producing dosed reaction gas in situ by electrolysis in at least one of the reaction chambers of one of the fuel cells; and
heating the fuel cell stack with waste heat from combustion of at least one of a primary and a secondary fuel by using surfaces covered with a catalyst as catalytic burners for the reaction gas during cold starting.

2. The method according to claim 1, which further comprises producing the reaction gas as required by electrolysis, through periodic polarity reversal of the cell.

3. The method according to claim 1, which further comprises producing the reaction gas to prevent the catalyst from being heated above 100° C.

4. The method according to claim 1, which further comprises additionally supplying heat from at least one of a heater and a reformer to the fuel cell stack.

5. The method according to claim 4, which further comprises conducting hot reformer gas from the reformer into a cathode area.

6. The method according to claim 4, which further comprises conducting hot reformer gas through an anode area, and supplying air or oxygen deliberately upstream or downstream.

7. A fuel cell battery for cold-starting according to claim 1, comprising:
at least one fuel cell unit including a centrally disposed electrolyte/electrode unit, reaction chambers each disposed on a respective side of said electrolyte/electrode unit, and axial process gas channels; and
at least one additional line leading into at least one of said reaction chambers and/or bipolar plates, to produce reaction gas there in situ by electrolysis during starting, for using surfaces covered with a catalyst as a catalytic burner.

8. The fuel cell battery according to claim 7, wherein said fuel cells are polymer-electrolyte-membrane (PEM) fuel cells.

9. The fuel cell battery according to claim 7, wherein said additional line produces an electrical contact between two electrodes and/or said adjacent bipolar plates and an external voltage source, for producing oxygen deliberately in said anode chamber, and/or for producing hydrogen deliberately in said cathode chamber during the in-situ electrolysis.

10. The fuel cell according to claim 7, including surfaces at least one of inside and outside said reaction chambers being covered with said catalyst and acting as catalytic burners once the reaction gas has been supplied to said surfaces as required.
